(19) United States
(12) Patent Application Publication
(10) Pub. No.: US 2026/0196633 A1
(43) Pub. Date: Jul. 9, 2026

(54) Structural Element for Rechargeable Battery

(71) Applicant: Hilti Aktiengesellschaft, Schaan (LI)

(72) Inventors: Julian HARBAUM, Peißenberg (DE); Charlotte LÖWE, Landsberg am Lech (DE); Philipp MARKERT, Augsburg (DE); Rene RICHTER, Augsburg (DE)

(21) Appl. No.: 19/131,496

(22) PCT Filed: Dec. 1, 2023
(86) PCT No.: PCT/EP2023/083857

§ 371 Date: May 20, 2025

(30) Foreign Application Priority Data
Dec. 14, 2022 (EP) 22213358.9

(51) Int. Cl. H01M 50/247; H01M 50/213; H01M 50/271

(52) U.S. Cl. CPC H01M 50/247; H01M 50/213; H01M 50/271; H01M 2220/30

(57) ABSTRACT

A rechargeable battery, in particular as a removable energy supply for a power tool, comprising at least one energy storage element and a battery housing with a cover element, four side walls and a base element. A first and second protrusion are arranged on at least the base element, wherein each protrusion has at least two sloping surfaces adjoining and opposite one another, and each arranged at an angle of 90° to 120°, preferably 105°, to one another, or each protrusion is configured substantially conical, wherein each conical protrusion has an opening angle of 90° to 120°, preferably 105°.

The present invention concerns a rechargeable battery.

### BACKGROUND

Rechargeable batteries (also known as accumulators) are widely known in the prior art as an energy supply for a power tool. These rechargeable batteries usually contain a number of energy storage cells (also referred to as battery cells), which serve and are designed to receive, store and deliver electrical energy. The receiving of electrical energy into the energy storage cells can also be referred to as charging (or recharging). The delivery of electrical energy from the energy storage cells can also be referred to as discharging.

For charging or recharging with electrical energy, the rechargeable battery is usually connected to a charging device (also called a charger). The charging device conducts electrical energy in accordance with a predetermined charging setting (also called the charging mode) having defined parameters for the actual charging process at the individual energy storage cells of the rechargeable battery.

The rechargeable battery usually has a relatively stable housing made of polyamide or similar. Although the battery housing is designed to be solid and particularly robust even for extreme loads, it serves primarily or exclusively as a storage container for the energy storage cells in order to protect these from dirt, moisture and moderate mechanical stresses.

### SUMMARY OF THE INVENTION

Misuse of the rechargeable battery, in particular use of the rechargeable battery as a substitute hammer for driving nails into materials, can however lead to permanent damage and/or total failure of the entire battery.

An object of the present invention is to solve the problem described above.

The present invention provides a rechargeable battery, in particular as a removable energy supply for a power tool, comprising at least one energy storage element and a battery housing with a cover element, four side walls and a base element.

According to the invention, it is provided that at least a first and second protrusion are arranged on at least the base element, wherein each protrusion has at least two sloping surfaces adjoining and opposite one another, and each arranged at an angle of 90° to 120°, preferably 105°, to one another, or each protrusion is configured substantially conical, wherein each conical protrusion has an opening angle of 90° to 120°, preferably 105°.

According to a further exemplary embodiment, it may be possible for the angle to amount to 75° to 90°. The more acute the angle, the better a nail (or similar) can be deflected such that the nail cannot penetrate into the base element.

According to an advantageous exemplary embodiment, it may be possible for a concave surface to be arranged between two protrusions.

The concave surface is here configured such that the lowest area of the concave surface is directed towards the rechargeable battery. It should also be noted that the concave surface has no single point tapering to a tip, but instead a face (or base area) is arranged at the lowest point of the concave surface.

According to a further advantageous exemplary embodiment, it may be possible that the at least one first and second protrusions are arranged on at least the cover element. Thus in a simple fashion, a nail or similar can be prevented from penetrating into the cover element if the battery itself (i.e. detached from a power tool or charging device) is used as a substitute hammer.

According to a further advantageous exemplary embodiment, it may be possible that the at least one first and second protrusions are arranged on at least one side wall. Thus in a simple fashion, a nail or similar can be prevented from penetrating into the side wall if the battery is used as a substitute hammer.

According to a further advantageous exemplary embodiment, it may be possible that the at least one first and second protrusions are arranged substantially over the entire surface of the base element, the cover element and/or at least one side wall.

According to an advantageous exemplary embodiment, it may be possible that the base element, cover element and/or at least one side wall at least in portions have a wall thickness of at least 3 mm. It must be noted that the wall thickness depends on the used material or substance of the battery housing. The harder and/or denser the used material or substance of the battery housing, the thinner the wall thickness may be. If the used material or substance of the battery housing is a polyamide, the wall thickness may amount to substantially 3 mm. If steel is used instead or in addition, the wall thickness may be less than 3 mm.

### BRIEF DESCRIPTION OF THE DRAWINGS

Further advantages can be found in the following description of the figures. A particularly preferred exemplary embodiment of the present invention is illustrated in the figures. The figures, the description, and the claims include numerous features in combination. A person skilled in the art will expediently also consider the features individually and combine them to form sensible further combinations.

Identical and similar components are denoted by the same reference signs in the figures, in which:

FIG. 1 shows a side view of a rechargeable battery according to the invention in a first exemplary embodiment;

FIG. 2 shows a perspective view of a partial region of a battery housing;

FIG. 3 shows a perspective view from below of the battery housing;

FIG. 4 shows a front view from below of the battery housing;

FIG. 5 shows a front view of the inside of the battery housing;

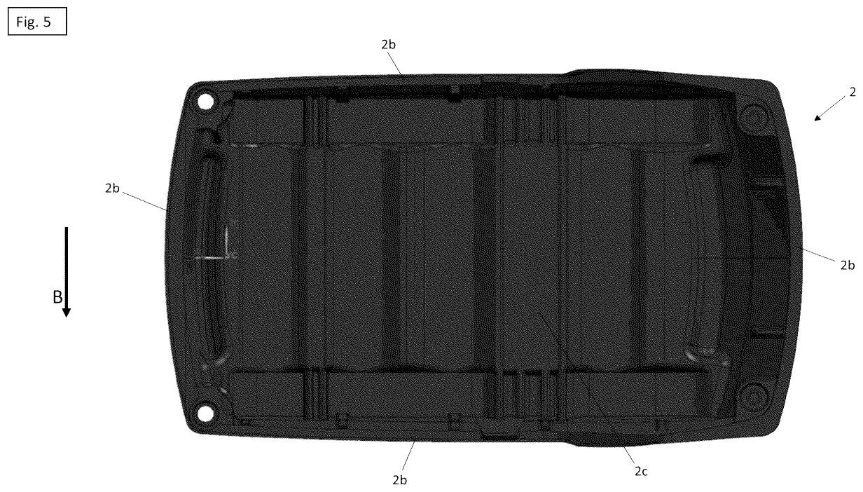

FIG. 6 shows a further side view of a partial region of the battery housing;

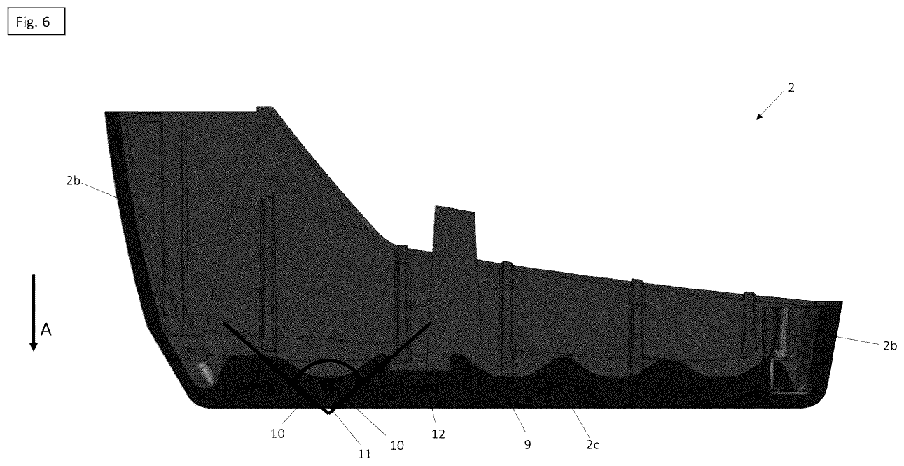

FIG. 7 shows a further perspective view of a partial region of the battery housing with energy storage elements;

FIG. 8 shows a further perspective view of a partial region of the battery housing with a cell holder for the energy storage elements;

FIG. 9 shows a further side view of a partial region of the battery housing with the cell holder and energy storage elements;

FIG. 10 shows a partial view of the cell holder and a base element of the battery housing;

FIG. 11 shows a further side view of a partial region of the battery housing with the cell holder and energy storage elements;

FIG. 12 shows a perspective view of a base element with a second embodiment of the protrusions;

FIG. 13 shows a perspective view of a single protrusion according to the second embodiment;

FIG. 14 shows a perspective view of a base element with a third embodiment of the protrusions;

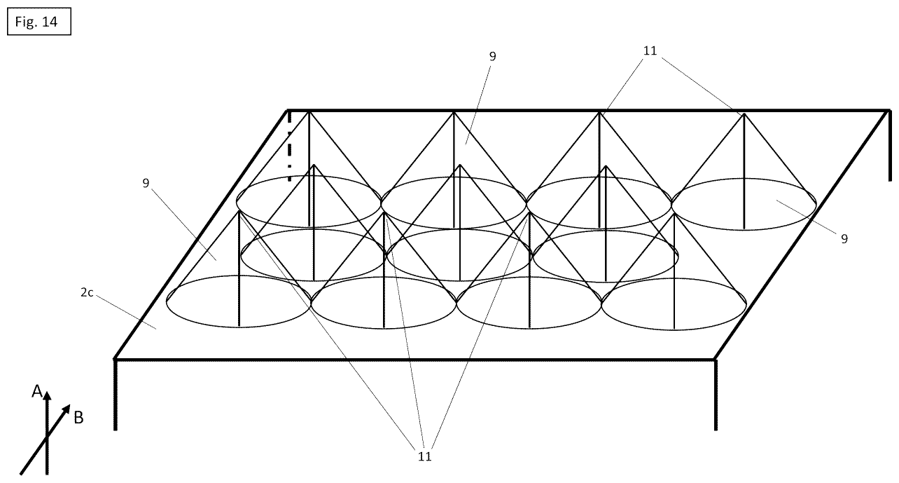

FIG. 15 shows a perspective view of a single protrusion according to the third embodiment;

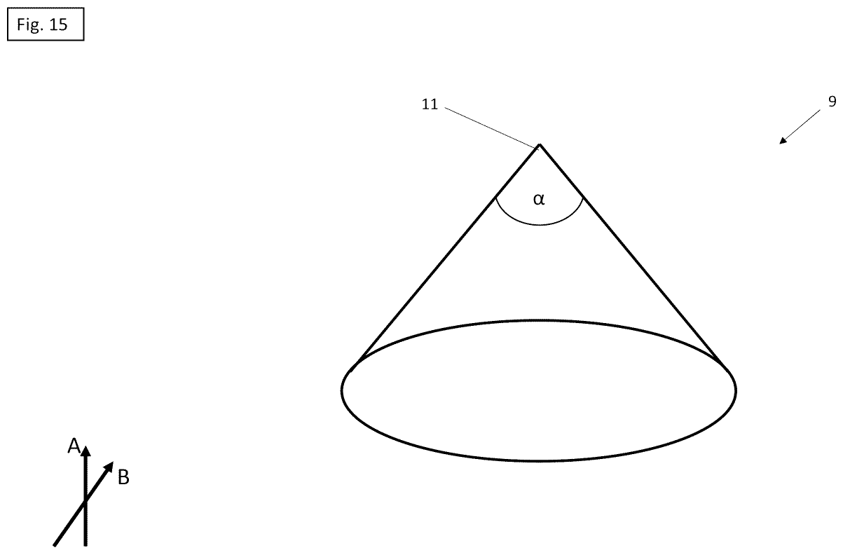

FIG. 16 shows a side view of the rechargeable battery according to the invention in a further exemplary embodiment; and

FIG. 17 shows a side view of the rechargeable battery according to the invention with energy storage cells arranged upright.

### DETAILED DESCRIPTION

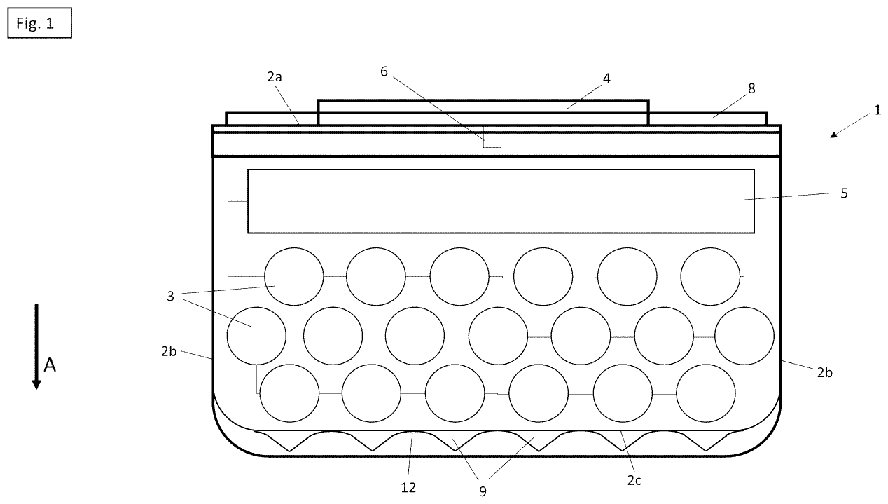

FIG. 1 shows a rechargeable battery 1 according to an exemplary embodiment.

The rechargeable battery 1 may be removably connected to a power tool in order to supply the power tool with electrical energy. The power tool is not shown in the figures, but may take the form of a hammer drill, power drill, cordless screwdriver, grinder, saw or similar.

The rechargeable battery 1 here substantially comprises a battery housing 2, a number of energy storage cells 3, a battery interface 4, and a control device 5.

The energy storage cells 3 may also be referred to as battery cells.

The battery housing 2 here substantially comprises a cover element 2a, four side walls 2b, and a base element 2c. The base element 2c is positioned on the battery housing 2 in the direction A.

The battery interface 4 serves to electrically or electronically and mechanically connect the rechargeable battery 1 to the power tool or a charging device.

The charging device is also not shown in the figures, but serves for recharging the energy storage cells of the rechargeable battery with electrical energy.

The energy storage cells 3 serve to receive, store, and re-deliver electrical energy.

As indicated in the figures, the energy storage cells 3 are cylindrical and configured on the basis of lithium-ion technology. Each energy storage cell 3 contains, at one end, a contact device which serves for the transmission of electrical energy.

The individual contact devices are connected to the control device 5 via corresponding lines 6.

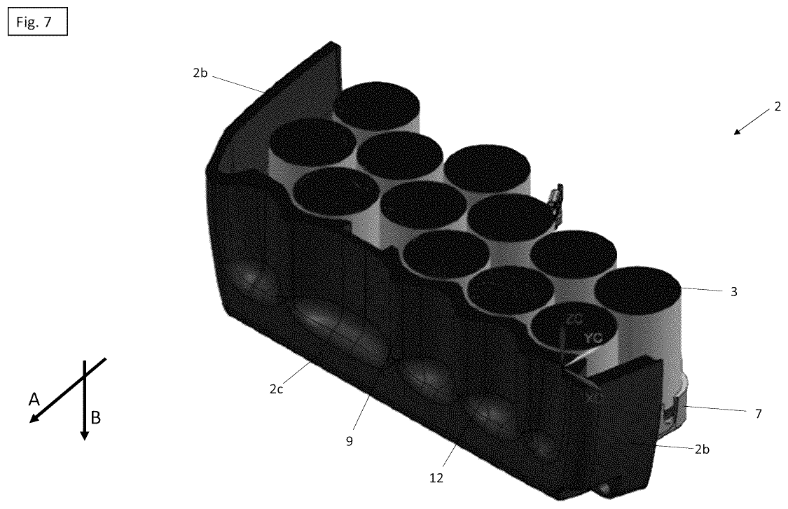

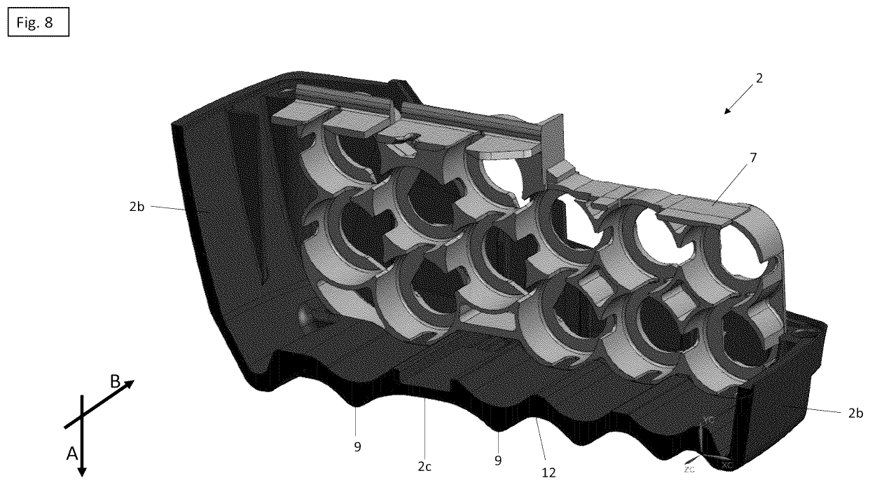

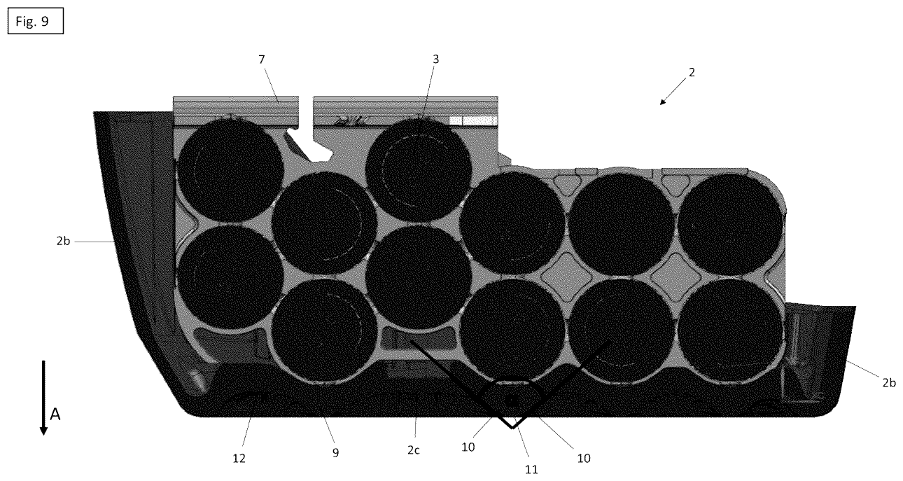

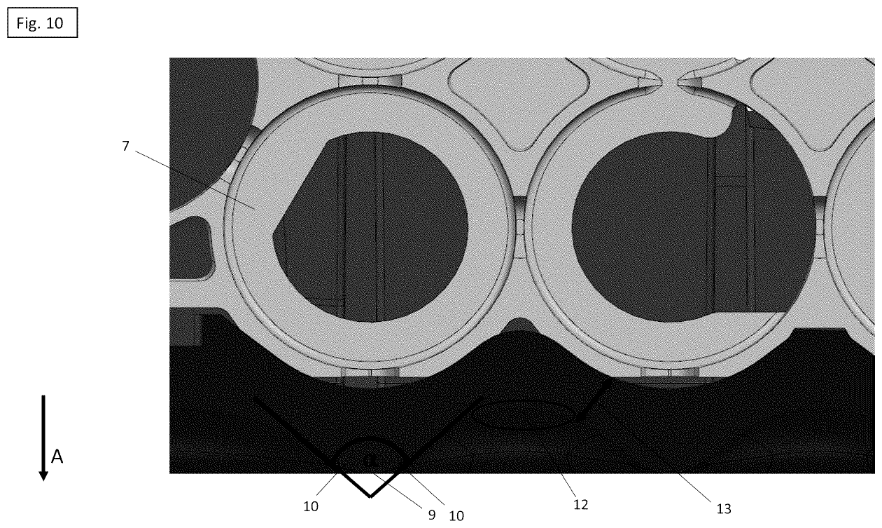

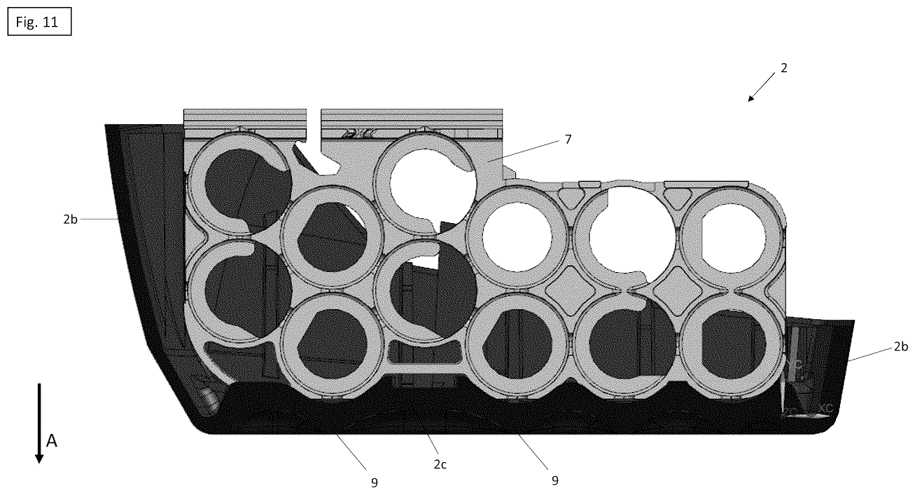

As indicated in FIGS. 7 to 11, the energy storage cells 3 are stationarily positioned in the interior of the battery housing 2 by a cell holder 7. FIGS. 7 to 11 show only part of the cell holder 7.

Alternatively, the energy storage cells 3 can also be based on another suitable technology.

The contact devices are not shown in the figures.

The cylindrical shape of the energy storage cells 3 is likewise optional, so any other suitable shape or geometry may also be selected. It is thus in particular also possible that the energy storage cells 3 are configured as pouch cells.

It is additionally also possible that the rechargeable battery 1 contains both cylindrical energy storage cells 3 and pouch cells. It is in particular possible that the rechargeable battery 1 contains a single cylindrical energy storage cell 3 and a single pouch cell.

The control device 5 controls the different functions of the rechargeable battery 1 in a closed-loop and open-loop manner. In addition, the control device 5 is connected to the energy storage cells 3 and the battery interface 4 via corresponding lines 6 such that electrical energy can pass from the energy storage cells 3 via the control device 5 to the battery interface 4.

To releasably mechanically couple the rechargeable battery 1 to the power tool, a rail apparatus 8 is provided.

A locking device (not shown in the figures) is used to removably connect the rechargeable battery 1 to the power tool (not shown).

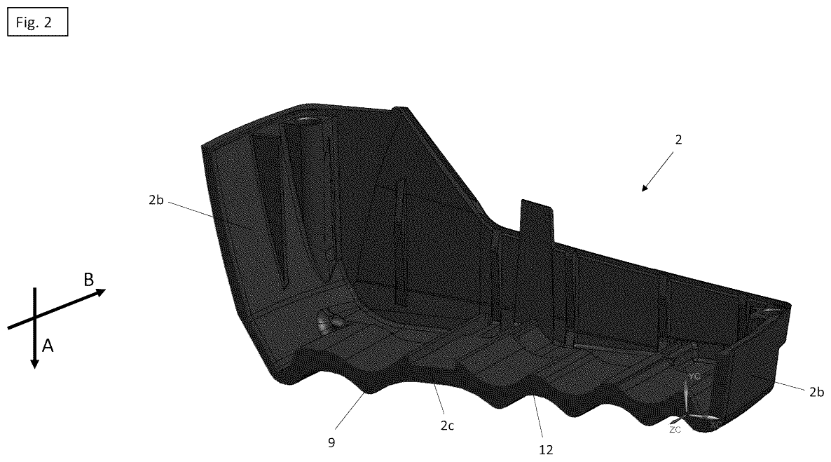

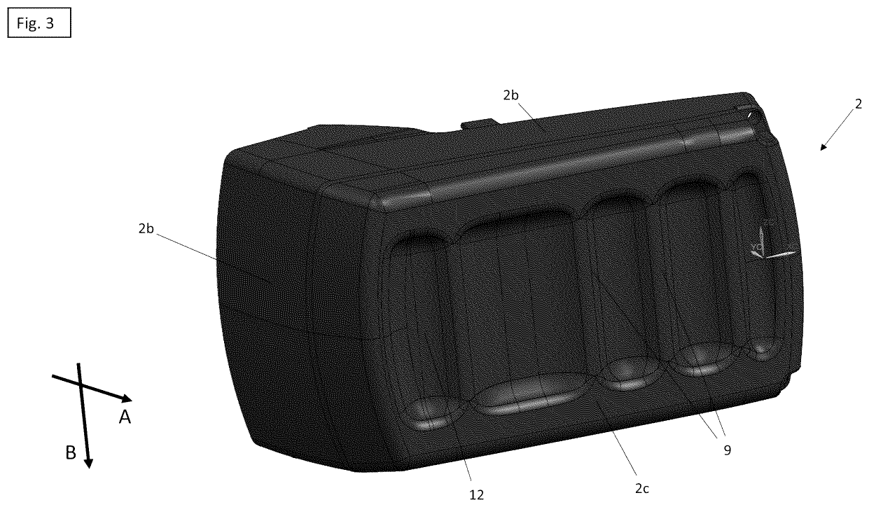

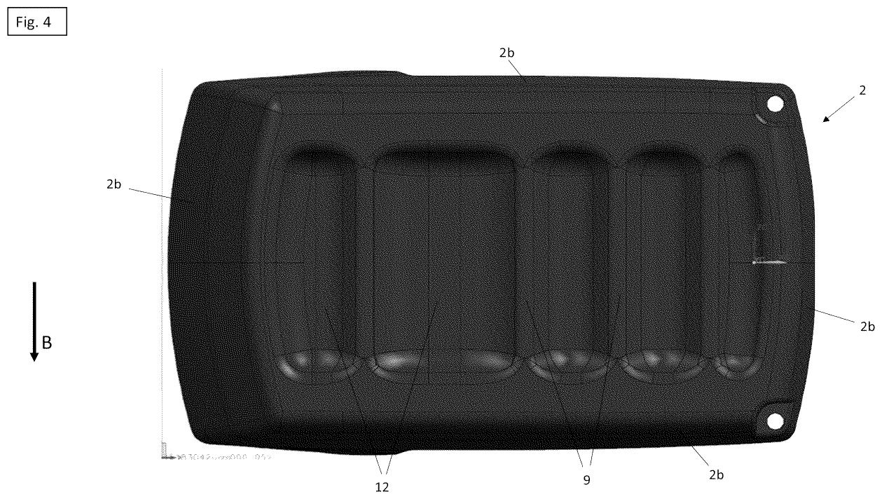

According to a first embodiment of the rechargeable battery 1 according to the invention, a plurality of protrusions 9 are positioned on the base element 2c of the battery housing. As evident in particular from FIGS. 2 to 4, according to the first embodiment, the protrusions 9 are arranged in elongate form in direction B over almost the entire width of the base element 2c. The protrusions 9 here run substantially parallel to one another. As indicated in particular in FIGS. 7 to 9, the energy storage cells 3 at the bottom in direction A are oriented or positioned towards the protrusions 9.

According to the first embodiment, each protrusion 9 has two sloping surfaces 10 (or side surfaces) adjoining and opposite one another. The tip 11, i.e. the side edge at which the two surfaces 10 meet, points in the direction of arrow A and hence away from the base element 2c. The angle a between the surfaces is 105°.

Alternatively, the angle a between the surfaces may also amount to between 90° and 120°. It is also possible that the angle a between the surfaces amounts to between 75° and 90°.

As also indicated in the figures, this region (in other words, the valley between two protrusions) is configured in the form of a concave surface 12. The corresponding convex surface points into the interior of the battery housing.

In addition, the wall thickness 13 of the base element amounts to 3 mm. Alternatively, the wall thickness 13 may amount to more or less than 3 mm. Furthermore, the wall thickness of a side wall 2b and the cover element 2a is also 3 mm.

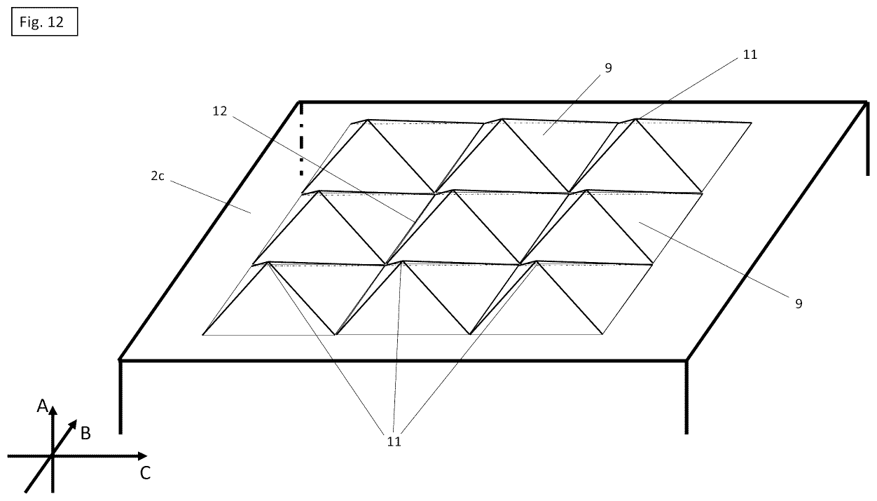

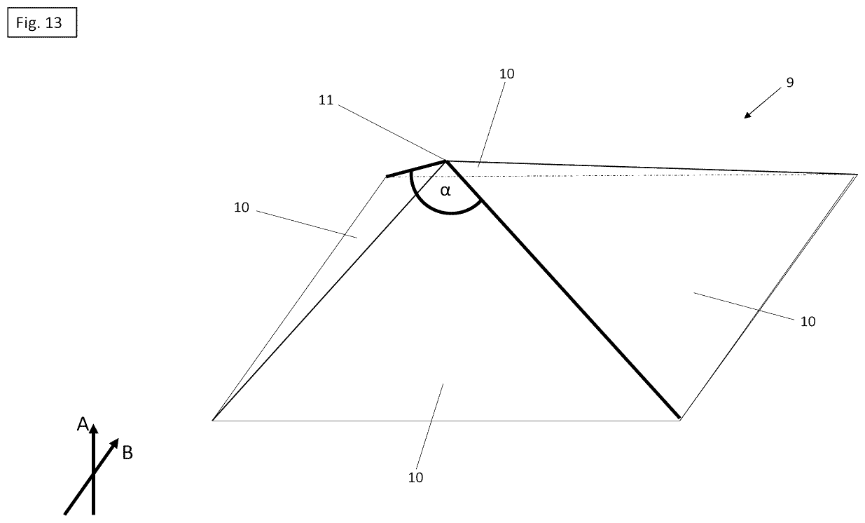

According to a further embodiment of the rechargeable battery 1 according to the invention, the protrusions 9 each have four faces (or side faces). The protrusions 9 are thus configured in the form of pyramids, see FIGS. 12 and 13.

As indicated in the figures, the pyramid-shaped protrusions 9 are oriented relative to one another such that several protrusions 9 in several rows are arranged along the directions B and C. The rows of protrusions 9 in direction B, and the rows in direction C, are arranged substantially parallel to one another. The rows of protrusions 9 in direction C are positioned substantially orthogonally or at right angles to the rows of protrusions 9 in direction B. The tips of the pyramid-shaped protrusions 9 run substantially in a straight line in the respective directions B and C.

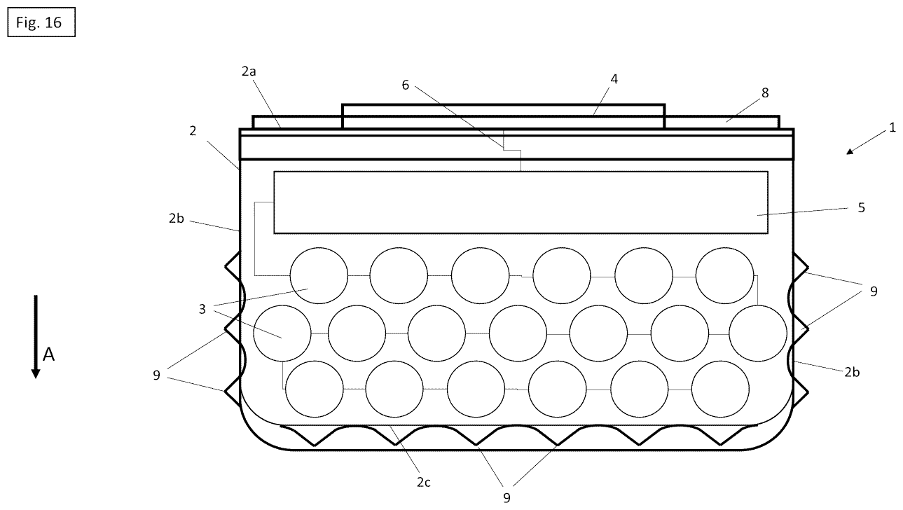

FIG. 16 shows a further exemplary embodiment of the rechargeable battery 1 according to the invention. In this exemplary embodiment, the protrusions 9 are configured as cones. In the figures, the conical protrusions 9 are shown with a tip.

According to an alternative embodiment, the tip of the conical protrusions 9 may also be blunted or rounded. In addition, it is also possible that the protrusions 9 are configured substantially as truncated cones.

According to a further embodiment of the rechargeable battery 1 according to the invention, the protrusions 9 are positioned on the cover element 2a and/or on the side walls 2b of the battery housing 2, see FIG. 16.

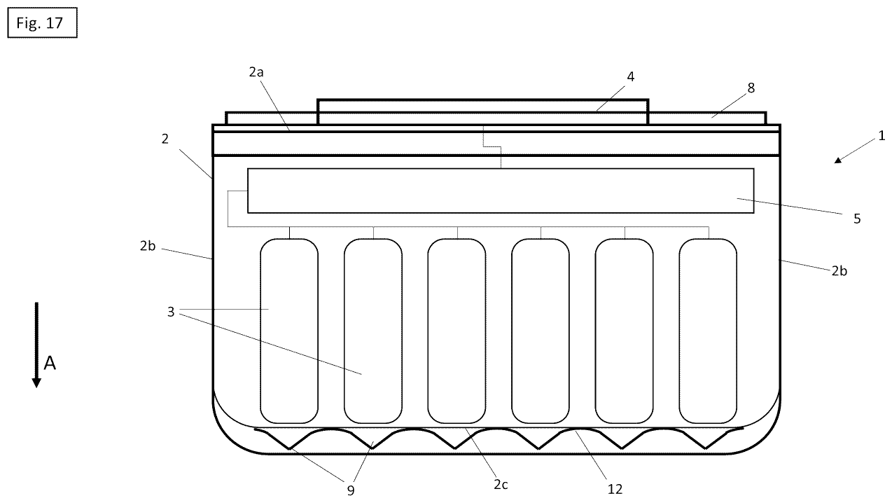

FIG. 17 shows a further exemplary embodiment of the rechargeable battery 1 according to the invention. The energy storage cells 3 of the rechargeable battery 1 are here arranged upright in the direction A. The protrusions 9 in direction A are arranged below each energy storage cell 3.

### LIST OF REFERENCE SIGNS

1 Rechargeable battery
2 Battery housing
2a Cover element
2b Side wall
2c Base element
3 Energy storage cell
4 Battery interface
5 Control device
6 Line
7 Cell holder
8 Rail apparatus
9 Protrusion
10 Area of protrusion
11 Tip of protrusion
12 Concave surface
13 Wall thickness of base element

What is claimed is:

1-6. (canceled)

7. A rechargeable battery comprising:
at least one energy storage element;
a battery housing with a cover, four side walls and a base; and
at least a first and second protrusion arranged on at least the base element, each of the first and second protrusions having at least two sloping surfaces adjoining and opposite one another, and each arranged at an angle of 90° to 120 to one another, or each of the first and second protrusions is conical with an opening angle of 90° to 120°.

8. The rechargeable battery as recited in claim 7 further comprising a concave surface between the first and second protrusions.

9. The rechargeable battery as recited in claim 7 wherein the at least one first and second protrusions are arranged on at least the cover element.

10. The rechargeable battery as recited in claim 7 wherein the at least one first and second protrusions are arranged on at least one of the side walls.

11. The rechargeable battery as recited in claim 7 wherein the at least one first and second protrusions are arranged over an entirety of a surface of the base element, the cover element or at least one of the side walls.

12. The rechargeable battery as recited in claim 7 wherein the base element, cover element or at least one of the side walls at least in portions has a wall thickness of at least 3 mm.

13. The rechargeable battery as recited in claim 7 wherein each of the first and second protrusions have the at least two sloping surfaces adjoining and opposite one another.

14. The rechargeable battery as recited in claim 13 wherein the angle is 105°.

15. The rechargeable battery as recited in claim 7 wherein each of the first and second protrusions is conical

16. The rechargeable battery as recited in claim 15 wherein the opening angle is 105°.

17. A removable energy supply for a power tool, the removable energy supply comprising the rechargeable battery as recited in claim 7.
